(19) United States
(12) Patent Application Publication
(10) Pub. No.: US 2006/0079281 A1
(43) Pub. Date: Apr. 13, 2006

(54) System and a method for a SIM card based multi-lingual messaging application

(75) Inventors: Vinjamuri Venkata Ravindra, Bangalore (IN); Vinjamuri Venkata Narasimha Rao, Bangalore (IN); Ramadevi Krishnan, Bangalore (IN)

Correspondence Address: BIRCH STEWART KOLASCH & BIRCH, PO BOX 747, FALLS CHURCH, VA, 22040-0747, US

(73) Assignee: Geneva Software Technologies Limited, Bangalore (IN)

(21) Appl. No.: 11/208,519

(22) Filed: Aug. 23, 2005

Related U.S. Application Data
(60) Provisional application No. 60/603,288, filed on Aug. 23, 2004.

(51) Int. Cl. H04B 1/38

(52) U.S. Cl. 455/558

(57) ABSTRACT

The present invention provides a Subscriber Identification Module (SIM) card based system and method for implementing pixel-based multi-lingual Unicode compatible messaging applications. The system comprises input and output units, SIM card, cellular based device and migration module in a transmission protocol server. The SIM Card with inbuilt language manager comprises a character formation member, input module to input desired characters, a display driver to effect display at output and a transmission protocol to transmit the message. The user-selected characters are displayed after accessing corresponding address locations and executing stored profile generating executables. Subsequently the corresponding layout management tasks are invoked and executed. Finally the resultant message which is a series of characters is displayed at the output unit and transmitted to transmission protocol server for performing product migration. Then, the product migrated message is retransmitted to another cellular based device.

The present application claims priority under 35 U.S.C. § 119(e) of U.S. Provisional application 60/603,288 filed Aug. 23, 2004, the entire contents of which are hereby incorporated by reference.

### TECHNICAL FIELD

The present invention relates to a system for a Subscriber Identity Module (SIM) card based multi-lingual messaging application for cellular devices. The present invention particularly relates to a system for implementing device independent pixel-based multi-lingual messaging application using standard transmission protocols by using a lower SIM card space. The present invention further relates to a method for implementing pixel-based multi-lingual message application for cellular devices.

### BACKGROUND AND PRIOR ART

Over the last few years, telecommunication system and in particular mobile telecommunication systems such as GSM (Global System for Mobile communication) and the like became widely spread all over the world. Due to an increasing competition between network operators, additional services besides the initial object of transmitting speech become essential. The aim of such additional services is to enable the creation of customized services that could be used by the mobile subscribers. Furthermore, the introduction of new services in telecommunication networks shall be facilitated. The central authority in such an intelligent network is a so-called service control point (SCP) which controls distinct calls. One example for an additional service is a so-called Localized GSM service. Another example of such a service is e.g. a prepaid SIM service in which calls are paid beforehand by the subscriber. A short message service (SMS) for transferring text messages is an example for a service which uses MAP services for transmitting data. It is for example commonly known to send short messages between two subscribers. It is also possible that a Voice Mailbox system could use short messages to indicate the presence of a recorded voice message to a subscriber. The SMS could need a short message service center for managing and controlling the transfer of such a short message.

There are several inventions in the field of additional services on the SIM (Subscriber Identity Module) card. One of the services is language SMS or short messaging service. In countries like India where there are multiple languages, this multi-lingual service will be useful. Especially in the rural areas where local languages are spoken and understood, this application will find tremendous demand. There are several prior inventions in the field of SIM based applications.

U.S. Pat. No. 6,667,748 describes a “Method of displaying image sequences on mobile radio communications equipment co-operating with a subscriber identity module”, the method including the following steps in order: the subscriber identity module sends an image sequence display command to said mobile equipment; and the mobile equipment executes the command on the display. This invention is mainly confined to the display of images on a Mobile Equipment using a SIM card. The SIM contains the images mostly in the form of Icons. These icons are sent to the Mobile Equipment using ‘pro-active’ commands.

U.S. Pat. No. 6,690,942 describes a “Mobile application part (MAP) interface for exchanging short messages with a SCP”. Here, a method for transmitting specific information between a controlling network element and a terminal device via a service center in a communication network is provided, said method comprising the steps of transmitting user data and said specific information between said network element and said service center via a first communication connection by using an interworking functionality; and forwarding at least said specific information from said service center to said terminal device by using a gateway functionality. It is further possible to check whether a confirmation for outgoing of said specific information to said terminal device is required. If such a confirmation is required, routing information for said controlling network element is requested and received by said service center from a network element. The routing information is used for transmitting a status report from said service center to said controlling network element. Moreover, the invention proposes a corresponding device and/or system. This invention deals mainly about the transmission protocol.

U.S. Pat. No. 6,671,522 provides a “Terminal controlled by a subscriber's identification module for running an application”. Here, a process for running an application has a terminal, which runs at least part of a terminal application under the control of a subscriber identification module cooperating with the terminal. The subscriber identification module and the terminal form part of a mobile station included in a radio communication system. Generally, the subscriber identification module sends a command to the terminal for the terminal to run at least part of a terminal application. The terminal executes the command, to run at least part of a terminal application and to take control. This invention deals with the incorporation of an application on the SIM to control a terminal. The description here is for a general application like “internet browser/access”.

U.S. Pat. No. 6,745,048 “SIM manager API”, wherein a SIM Manager is disclosed that accesses functionality contained within a GSM-type telephone SIM by combining functionality of a plurality of asynchronous RIL functions into a single synchronous application programming interface. A first dynamic link library receives a function call for performing a selected function from an application operating in a GSM-type telephone device. The first dynamic link library is preferably a stub dynamic link library to which applications link, links to the application and initiates a process thread corresponding to the received function call, thereby blocking all subsequently received calls until the received function call for the selected function is complete. A second dynamic link library contains at least one application-programming interface corresponding to the selected function. Each application-programming interface corresponds to the selected function within the second dynamic link library links to a radio interface layer of the GSM-type telephone device for performing the selected function. The second dynamic link library is loaded by the first dynamic link library when the first dynamic link library receives the function call. The second dynamic link library initiates a process thread corresponding to the received function call and blocks all subsequently received calls until the received function call for the selected function is complete.

U.S. Pat. No. 6,744,423 describes a “Communication terminal having a predictive character editor application”. Here, a user interface for a text entry device, comprising: a display having a first display section and a second display section, and a keypad including a set of text entry keys each having a set of characters associated therewith. The set of characters associated with each of the text entry keys being displayed in the second display section. A predictive character editor engine with associated directories is adapted to receive a string of input strokes and to output a list of matching word candidates in response thereto. A controller receives inputs from a set of text entry keys, and generates said string of input strokes for the predictive character editor. The controller presents in said first display section at least one of said matching word candidates from the predictive character editor for selection by the user. This invention deals with an advanced language input method, which is a predictive-text method. Basically a dictionary is provided to compare the word being typed and suggestions are generated. The user can choose appropriate suggestions.

The prior art inventions provide language input methods, usually a predictive text method pertaining to mainly the English language. For Indian or other Asian languages this predictive text method is too complicated.

Conventional SIM cards interact with a centrally located server which has databases stored in it. Whenever the SIM card has to acquire some information which is stored in the database of the server, a means of communication has to be established by the SIM card with the server. For instance in case of flight information systems, the information of flights from one place to another is stored in the database of the server. In case a mobile or cellular user requires to know the flight details from say Bangalore to Singapore, he has to send a request (Short Messaging Service (SMS) to the server (which will have a particular number). The server then processes the request of the user from the available data in its database and will in turn send an SMS to the user's cellular device informing him the available timings of the flight from the source place to the destination place. The obvious disadvantage of this method being, the delay in time to procure the information and deficiency in the SIM card to store the amount of data.

None of the above mentioned prior art inventions provide a SIM card that can overcome the above-mentioned disadvantage.

### OBJECTS OF THE INVENTION

The primary object of the present invention is to provide a SIM Card and a system for implementing multi-lingual messaging application on a standard GSM or CDMA or other appropriate transmission protocols.

An object of the present invention is to provide a SIM Card and a system for implementing device independent pixel-based multi-lingual messaging application on a SIM card.

Another object of the present invention is to provide a SIM Card and a system for implementing a multi-lingual messaging application occupying low space on the SIM card.

Yet another object of the present invention is to provide a self-sufficient SIM card and a system for implementing a multi-lingual messaging application, which functions in real-time without any communication with the server for multi-lingual message creation.

It is also an object of the present invention to provide a SIM Card and a system for implementing a multi-lingual messaging application for Unicode compatible languages.

Still another object of the present invention is to provide a SIM Card and a system for implementing a multi-lingual messaging application engine on the SIM Card for composing, editing, sending and receiving Multi-lingual SMS messages.

Yet another object of the present invention is to provide a SIM Card and a system for implementing an interactive multi-lingual messaging application for sending Short Messaging Service (SMS) and language Messaging Service (LMS).

Yet another object of the present invention is to provide a SIM Card and a system for implementing a multi-lingual messaging application with Language Characters (Virtual Font), Key logic and Layout Management component.

Still another object of the present invention is to provide a SIM card and a system for implementing a multi-lingual messaging application with a server-based migration module for product migration of the message from a source language to any other target language while retaining complete meaning and context.

It is also an object of the present invention to provide a method for implementing pixel-based multi-lingual message application for cellular devices.

### SUMMARY OF THE INVENTION

The present invention provides a SIM card based system for implementing pixel-based multi-lingual Unicode compatible messaging applications. The Subscriber Identification Module (SIM) Card of the system of the present invention is provided with an inbuilt language manager for implementing pixel-based multi-lingual Unicode compatible messaging applications. The SIM card comprises a language manager which in turn comprises of a character formation member which is a pixel-based renderer of multi-lingual characters from a combination of glyphs, an intelligent text input module driven by keypad driver to input characters in the user-selected language, a display driver to effect the display of fused or merged characters in a series to form a message and a transmission protocol to transmit the message. The message transmission protocol is selected from GSM, CDMA and other appropriate transmission protocols. The system for implementing pixel-based multi-lingual Unicode compatible messaging applications comprises an input and output units, a SIM card disposed with an inbuilt language manager for implementing pixel-based multi-lingual Unicode compatible messaging applications and a cellular based device. Initially a functional linkage is established between the SIM card having an inbuilt language manager for implementing pixel-based multi-lingual Unicode compatible messaging applications and cellular based device. The user then selects the messaging application. The user selects a language from a plurality of languages and a character and/or character modifier to be displayed from selected language from a menu-based user-friendly mode by means of an input unit. An appropriate address of the address location for the selected character and/or character modifier is fetched by mapping from the database member. This address location comprises of corresponding character and/or character modifier profile generating executables. Now, the address of the selected address location is shifted to a memory member. Then, the corresponding character and/or character modifier profile generating executables are secured from the address location, into the memory member, by the language manager. The language manager generates a pixel sequence, which is associated with the shape of the character and/or character modifier and the same is stored in the memory. The layout management tasks corresponding to the resultant character and/or character modifier is invoked from the database and then executed, displaying the resultant character along with the fused modifier, wherever applicable. The above steps are repeated till desired number of characters is displayed at the display unit, thereby displaying series of resultant characters along with fused modifiers by repeating the aforesaid steps to form a message and thereby transmitting the resultant message to another cellular based device. Optionally, the transmitted message can be product migrated into any other desired language and then sent to the receiving cellular device.

### Brief description of the diagrams

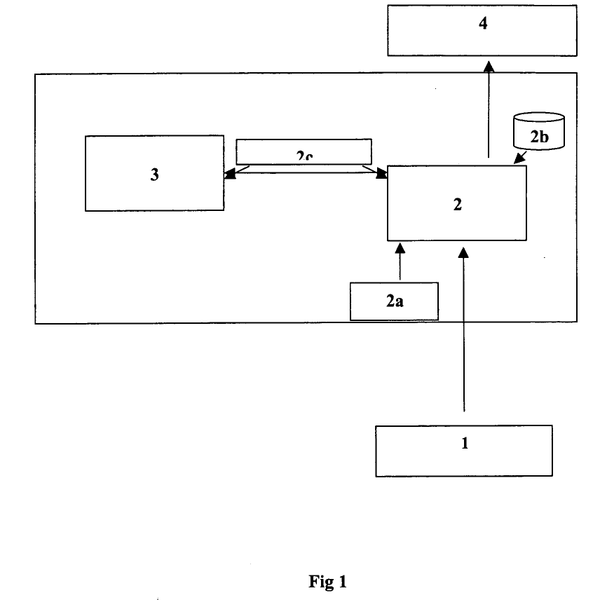

FIG. 1 depicts the block diagram of the system of the present invention

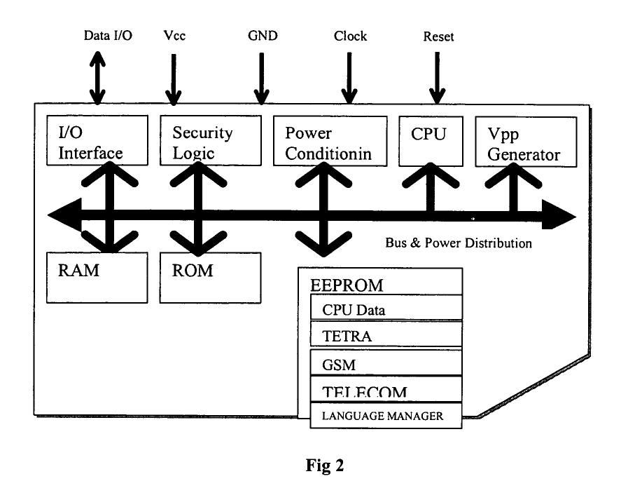

FIG. 2 depicts the block diagram of the SIM card of the present invention.

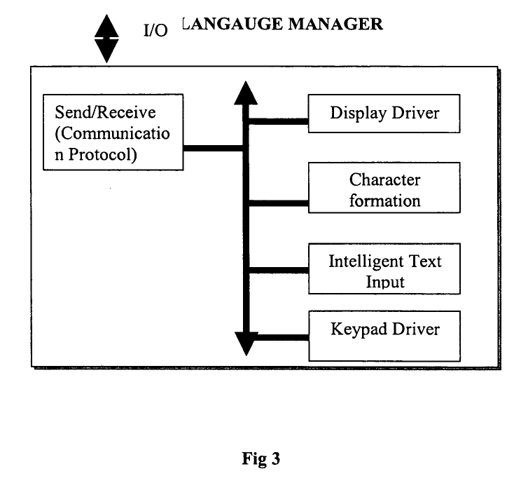

FIG. 3 depicts the composition of the language manager present in the SIM card of the present invention.

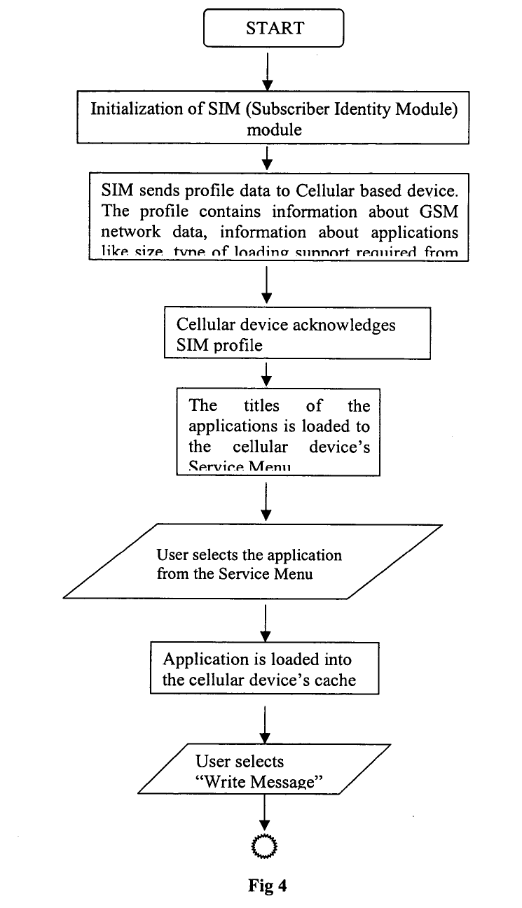

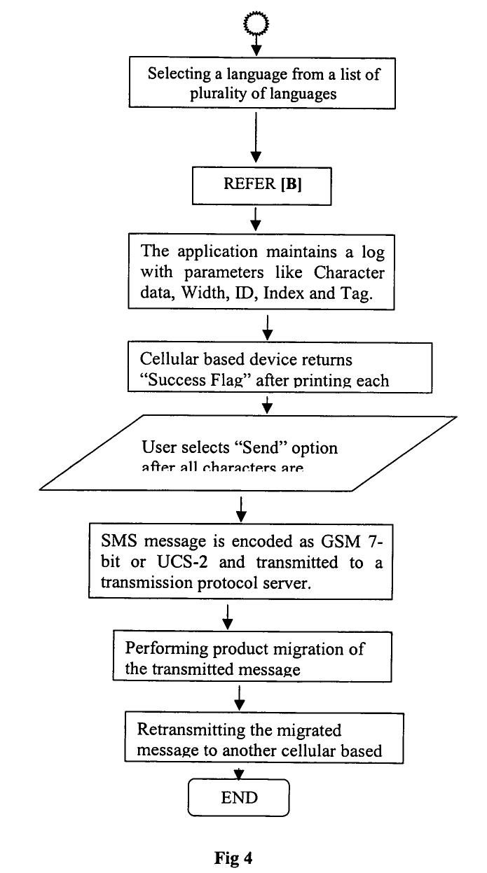

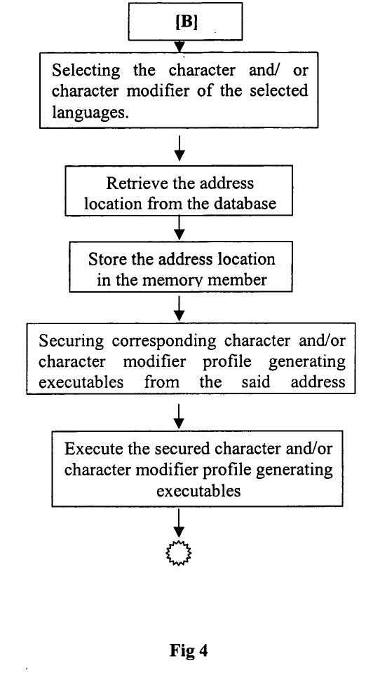

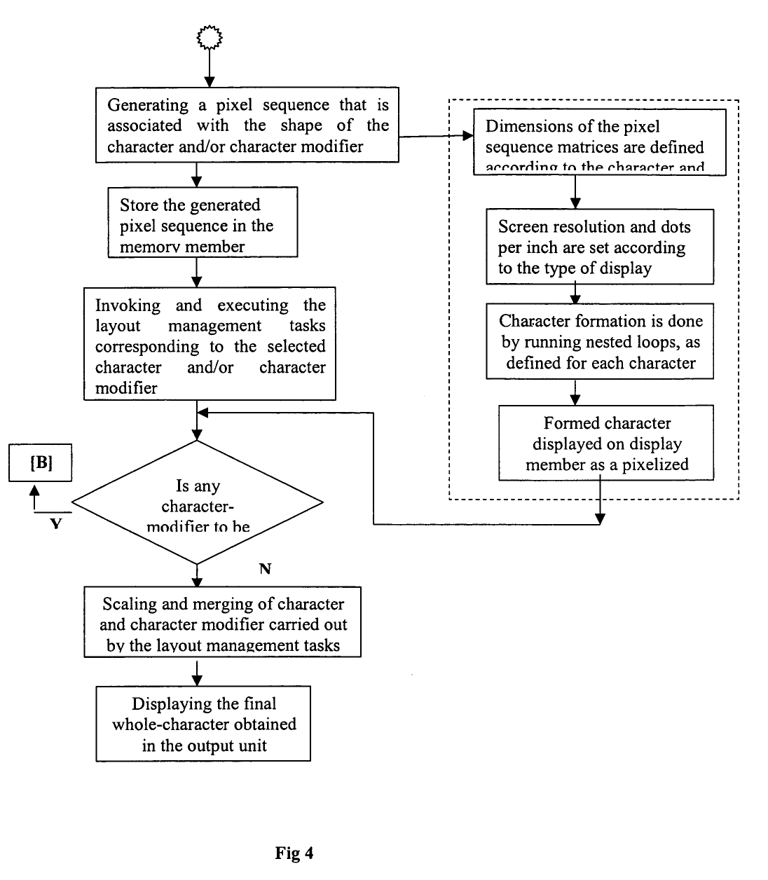

FIG. 4 shows a flow diagram of the multi-lingual messaging method of the present invention.

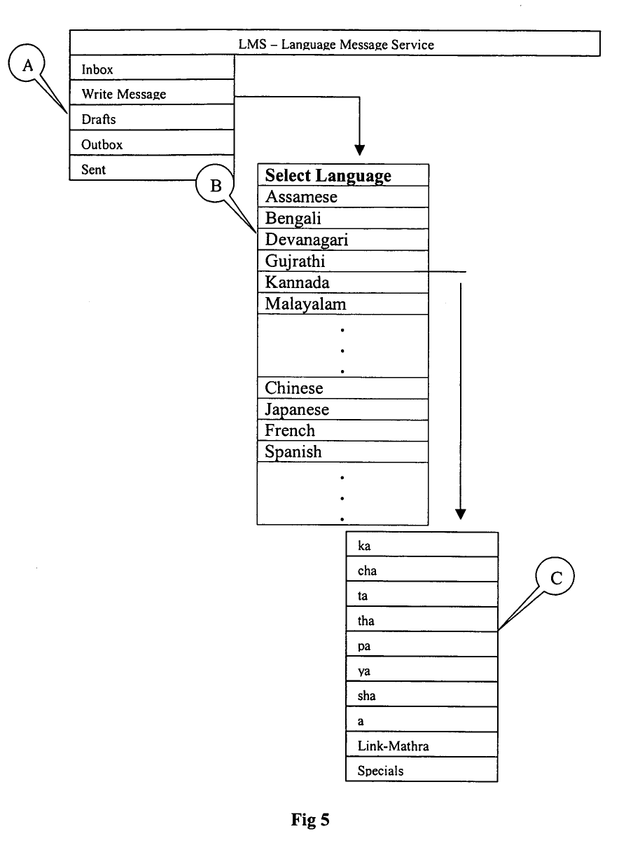

FIG. 5 depicts the multi-lingual messaging main menu displayed at the output unit of the system of the present invention

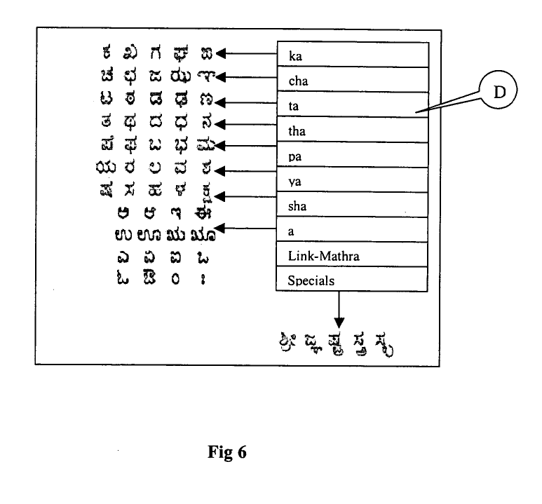

FIG. 6 depicts the structural details of the menu-based input for the multi-lingual messaging method of the present invention.

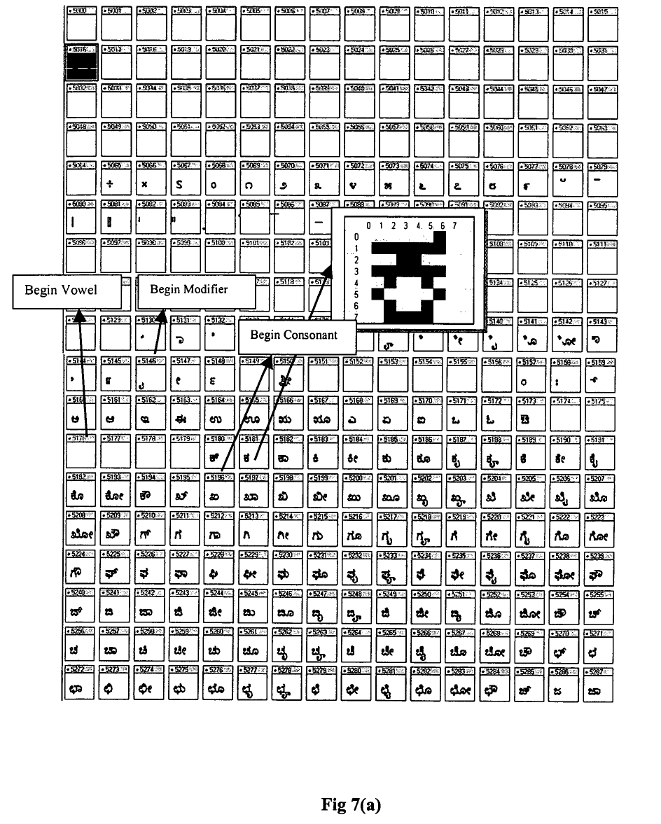

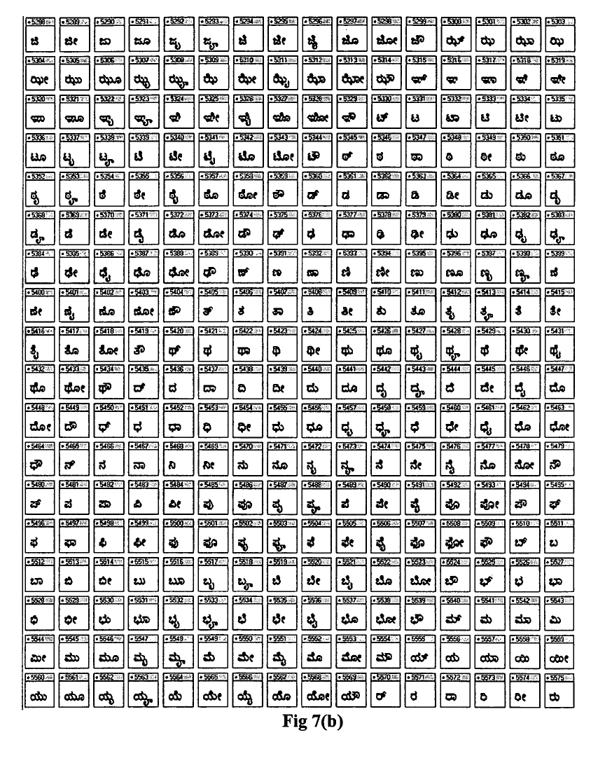

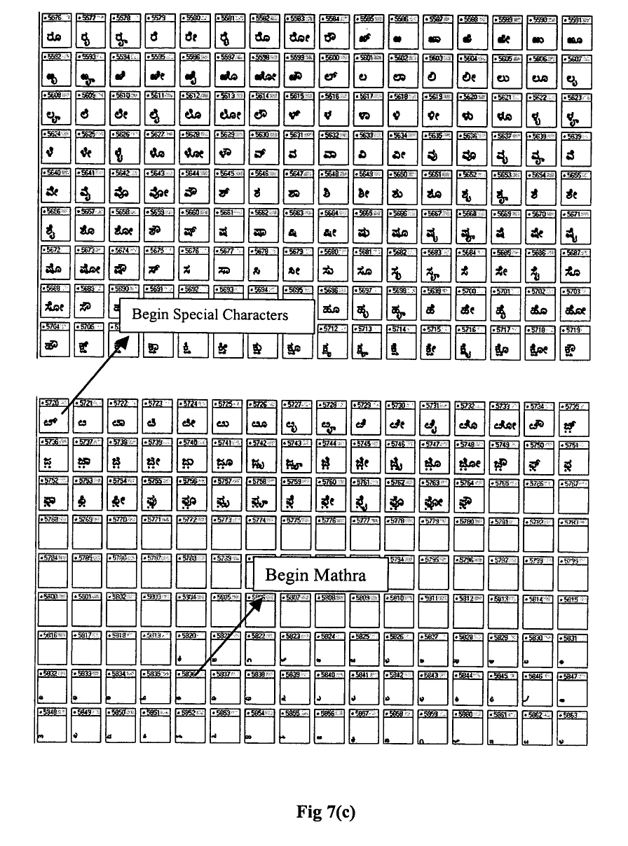

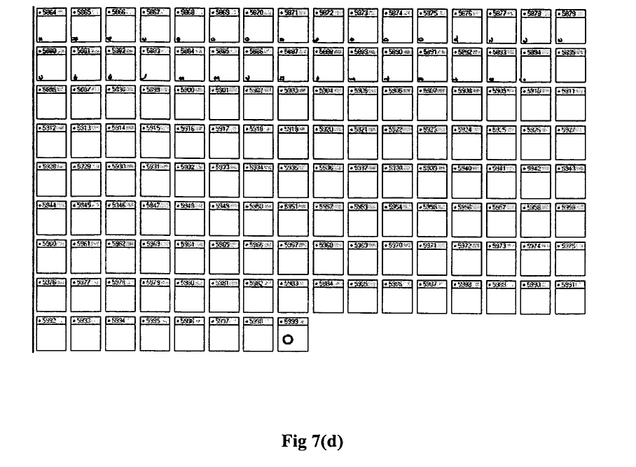

FIG. 7 (a), (b), (c) & (d) is an exemplary embodiment of the present invention depicting the address locations allocated specifically for Kannada language and the specific character that each address generates.

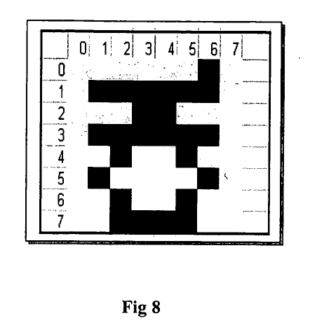

FIG. 8 depicts a character matrix for a character in Kannada Language (An Indian language)

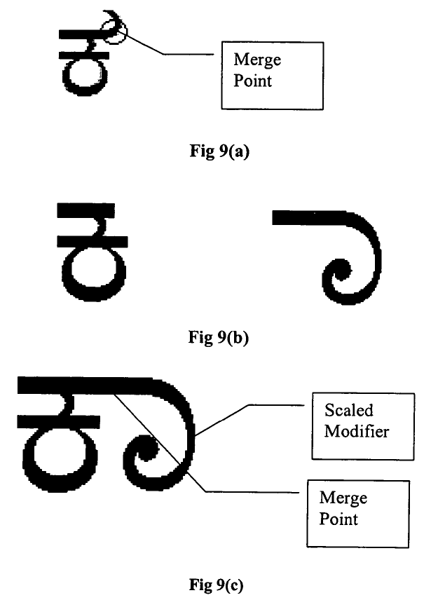

FIG. 9 (a), (b) & (c) depict various stages involved in the formation of character matrix from a combination of single character and a character modifier.

### DETAILED DESCRIPTION OF THE INVENTION

The present invention provides a system for implementing device independent pixel-based multi-lingual messaging application on a SIM (Subscriber Identity Module) card in a cellular based device. The SIM card used in the present invention is a standard GSM (Global System for Mobile communication) or CDMA (Code Detect Multiple Access) card or card used by any other appropriate transmission protocols. Now, the system configuration of the system of the present invention is explained by initially referring to its schematic representation as depicted in FIG. 1. Referring to FIG. 1, the system of the present invention comprises input and output units, a SIM card with an inbuilt language manager for implementing pixel-based multi-lingual Unicode compatible messaging applications, a cellular based device and a migration module disposed in a transmission protocol server to perform product migration (intelligent translation and transliteration) of the transmitted message.

The input unit (1) of the system of the present invention may be selected from a keyboard or keypad unit of the cellular based device. The input unit (1) is any known input devices that are commonly used for cellular devices. It is also within the purview of the invention to use a device with touch-screen input features. The handset that is used in conjunction with the system of the present invention is any mobile or cellular handset. The system of the present invention is adaptable to any cellular device of PHASE 2 plus configuration. In the present invention, the device (hand set) (2) of the system constitutes an external unit. The cellular device (2) is provided with a cache memory unit (2a) and is incorporated with a database unit (2b). The cache memory (2a) of the cellular based device (2) is a volatile memory and is utilized during processing of the cellular based device (2) to store information temporarily. The database unit (2b) of the cellular based device (2) contains information including booting sequence and other components like keypad mapping tables, phone book data, phone settings, clock information, etc, that are required to operate the cellular device (2). It is understood here that contents of the database unit (2b) are product specific and can vary from one cellular device to another. The cellular device (2) is driven by rechargeable power supply unit (2c), which supplies necessary power for the operation of the cellular based device (2).

A SIM (Subscriber Identity Module) card of the present invention (shown in FIG. 2) is provided with an inbuilt language manager for implementing pixel-based multi-lingual Unicode compatible messaging applications. The SIM card comprises a Central Processing Unit, which comprises the heart of the SIM card, the voltage generator (Vpp) which provides the power supply to the SIM card and a power conditioning unit which stabilizes the power for optimal voltage and current ratings. The power supply to the SIM card is obtained from the common battery of the cellular based device. The SIM card additionally contains a security logic which provides the necessary administrator rights for the data to be written into the SIM card and also stores the logic for the GSM stack security protocol. In addition to the above, the SIM card also has a Random Access Memory (RAM) and Read Only Memory (ROM), which are respectively used for volatile and non-volatile memory applications. The SIM card communicates with the external receptors like cellular or mobile devices by means of an input-output interface, which functionally connects the SIM card with the cellular based device. The additional feature that is provided in the SIM card of the present invention is in the form of a language manager which resides in the ROM (EEPROM in this case) of the SIM card as shown in FIG. 2.

The inbuilt language manager (as shown in FIG. 3) of the SIM (Subscriber Identity Module) card (3) comprises a character formation member, which is a pixel-based renderer of multi-lingual characters from a combination of glyphs, a keypad driver which maps the input keys, an intelligent text input module driven by the keypad driver to input characters in the user-selected language, said input module is provided with language menu to select the desired a language menu, character group and character; a display driver to effect the display of fused or merged characters and a message transmission protocol. The message transmission protocol is selected from GSM, CDMA and other appropriate protocols. In a CDMA type of transmission protocol, there is no provision for a SIM card. In such protocols the cellular device itself acts as an identity module in place of the SIM card. In case the CDMA network is not available, the connectivity is enabled using a RUIM (Removable User Identity Module) card. In such cases the user shall be provided a GSM SIM card (or RUIM card) and a cellular device number using which he can access CDMA network. In such cases the language manager having the multi-lingual messaging application can be disposed into the RUIM card. Thus the present invention is compatible with both GSM as well as CDMA transmissions protocols as well as other appropriate transmission protocols.

The character formation member of the language manager stored in the SIM card (3) is a pixel-based renderer of multi-lingual characters from a combination of glyphs. This character formation member comprises a database member and a layout management component. The database member stores languages and address locations having character and/or character modifier profile generating executables. The layout management component is provided to scale the height and width of the character and character modifier as per dimensions and dots per inch of display. This layout management component is also disposed to fuse or merge the scaled character with the scaled character modifier at the points of scaling, to form the resultant character along with the fused modifier and to determine spacing between any two resultant characters and spacing within each individual character, wherever applicable.

Basically, the data in the database member is stored such that the address location, the character and/or character modifier profile generating executable and the layout management tasks for every character and/or character modifier is stored adjacent to each other for easy retrieval. This is easily accomplished by use of a 3-dimensional matrix structure for the database member. The storage of a typical alphabetical sequence in the database member for the alphabets of Kannada language is shown in a 3-dimensional structure, said 3-dimensional structure consisting of, address locations, character profile generating executables and layout management tasks. The 3-dimensional matrix structure has been depicted below by means of a pictorial representation.

[image]

The languages are stored in the database member, preferably in the form of a table, which comprises a range addresses to accommodate the character set of each of the Unicode compatible languages. A sample table (Table 1) is provided below showing the address locations that have been assigned to selected Indian languages to make it compatible with Unicode Standards. Similarly, the address locations are also assigned for other Unicode compatible languages such as Chinese, Japanese, Korean, Spanish

TABLE 1

| SI. | Indian Language | Range of address spaces |
|---|---|---|
| 1 | Devanagari | 4000-5000 |
| 2 | Kannada | 5000-6000 |
| 3 | Telugu | 6000-7000 |
| 4 | Tamil | 7000-8000 |
| 5 | Malayalam | 8000-9000 |
| 6 | Oriya | 9000-10000 |
| 7 | Bengali | 10000-11000 |
| 8 | Gujarati | 11000-12000 |
| 9 | Punjabi | 12000-13000 |
| 10 | Sanskrit | 13000-14000 |
| 11 | Assamese | 14000-15000 |
| 12 | Urdu | 15000-16000 |

Indian languages Hindi and Marathi adopt an ancient Devanagari script, which is a common script for both the languages. Therefore, both these languages are included as a single entity under Devanagari script and as a result these two languages have been allotted address locations viz., 4000-5000. Consequently, the actual number of Indian languages that can be supported by the present invention is 14.

In addition to storing the address locations having character and/or character modifier profile generating executables, there are certain address locations which are kept empty in the database for scalability and addition of possible new characters to that language in future.

In an exemplary embodiment, we refer to FIGS. 7a, 7b, 7c & 7d of the accompanied diagrams, wherein an allocation of address locations for an Indian Language—Kannada, which is the Official language of the State of Karnataka, India. A specific character and/or character modifier that is stored in the address location is depicted in the form of character images and/or character modifier image for sake of clarity. However, in reality the images of the characters or character modifiers are not stored, but instead executable modules of such specific character and/or character modifiers are stored.

When the specific character and/or character modifier is called, the corresponding character and/or character modifier profile generating executable is run and a character and/or character modifier matrix is generated which is unique to every character and/or character modifier.

For instance, in FIG. 7a, a single character in address location 5181 is shown in its matrix form (pixelized matrix). Similarly, all other characters and/or character modifiers also have their specific executable modules and their corresponding matrix forms. It may be note here that for sake of clarity all the characters and/or character modifiers have been depicted in their image forms and not depicted in their matrix forms.

In the present invention, as an exemplary embodiment, the address locations provided for the Kannada language is between 5000-6000. All the characters of the Kannada language have been defined within the above range of address places. FIG. 7 depicts the address places that have been allocated for each character of the Kannada language. As shown in FIG. 7, each address place is allocated for a single character. Each address place basically is a 16-bit (4 digit) number.

The vowels of the Kannada language are placed in the top row from address place commencing from 5160 and the consonant series starts from address place 5180. Consonants with modifiers are allocated from 5130. Address locations up to 5720 are allotted to other signs and special characters. Further, blank address locations are also allotted to provide scalability.

The SIM card (3) as shown in FIG. 2, additionally stores the GSM, CDMA or any other transmission protocol stack, the address book and an application area. The GSM (Global System for Mobile communication) stack contains the necessary data for communicating using GSM protocols. In case CDMA mobiles are used there will be a CDMA stack in the SIM card (3) in place of the GSM stack. The address book stored in the SIM card (3) contains necessary data to store names, addresses and phone numbers. The messaging application is used for the short messaging services (SMS). The application area of the SIM card contains additional applications inserted by the service provider. The distribution of the SIM card capacity is shown in Table 2 as shown below. This table provides the distribution of SIM card capacity considering the total SIM card capacity to be 32 KB. The present invention can be implemented on Nonjava as well as Java based SIM cards, and both the types of SIM cards can be of sizes in the range 8 KB, 16 KB, 32 KB, 64 KB and 128 KB. The present invention is described for a 32 KB SIM card, however this should not be considered as limiting the scope of the invention and the present invention can be used for SIM cards of any capacity.

TABLE 2

| Particulars | Size | |
|---|---|---|
| GSM (Global Communication Standard for Mobiles) | 10-15 | KB |
| Stack | | |
| Address Book | 3-5 | KB |
| Messages | 5-8 | KB |
| Application Area | 5 | KB |

The application area provided in the SIM card is the only available space for additional services, which will be provided by the service provider. The only way to increase the application area is to compromise on the other particulars like address book space or message space. For additional space, the Address Book and Messages have to be optimized to about 50% so that 6.5 KB to 8.0 KB is available for porting a new application. The new applications that are provided by the service provider may be for instance, Wireless Internet Browser (WIB). The present invention utilizes this application area available to place the device independent multi-lingual messaging application engine.

The SIM card memory is used during the processing of the SIM during operation of the mobile for messaging or other applications. The applications are stored in the application area of the internal SIM card (3). In the present invention the application that is stored in the application area is a multi-lingual messaging application in the form of a language manager. This multi-lingual messaging application is accommodated within the application area in the SIM card (3) i.e. within a space of 5 KB for a 32 KB SIM card. The components of the multi-lingual messaging application language manager as stored in the SIM card (3) are depicted in FIG. 3.

The SIM card (3) is functionally linked with the cellular based device (2). The SIM card (3) may be inserted within the cellular based device (2) or may be functionally connected by any other known means of connectivity. The SIM card (3) and the cellular based device (2) are connected by a data bus. The power supply unit (2c) of the cellular based device (2) also provides necessary power supply to the internal SIM card (3).

The output of the cellular based device (2) is provided to an output unit (4), which is interfaced with the cellular based device (2). The output unit (4) is a display unit, which is a conventional mobile display. The output unit (4) depends on the cellular based device and varies in size, resolutions and other factors depending on the cellular based device type.

The message that is created using the system of the present invention, is transmitted to another cellular device by using the standard GSM, CDMA or other appropriate transmission system. The system of the present invention is provided with a migration module which is disposed in the transmission protocol server (either GSM or CDMA server or other appropriate protocols). The migration module performs product migration which includes intelligent translation and transliteration of the transmitted message and transmits the migrated message to the receiver cellular device.

The present invention describes a method for implementing device independent pixel-based multi-lingual Unicode compatible messaging applications in cellular based communications using a standard GSM or CDMA SIM (Subscriber Identity Module) card.

The method of the present invention is described by referring to FIG. 4. FIG. 4 shows a flow diagram depicting the method of the present invention.

Initially a functional linkage is established between the Subscriber Identification Module (SIM) card having an inbuilt language manager for implementing pixel-based multi-lingual Unicode compatible messaging applications and the cellular based device (2). This functional linkage may be established by inserting the SIM card within the appropriate slot in the cellular based device (2). Subsequently, the cellular based device (2) is powered-on by means of the power supply unit (2c). The internal SIM card (3) and the cellular based device (2) are both supplied power and the internal communication between them is initialized.

When, the system of the present invention is powered on, corresponding initialization routines pertaining to environment settings are executed to seek basic display resolution parameters such as height, width and resolution (dots per inch).

The height and width parameters signify the space available for the system to draw the selected character or character modifier on the display member (4). The display width and height are recorded by the layout management module stored in the database of the language manager, for use during the execution of layout management tasks. The resolution or dots per inch of the display member (4) is also recorded by the layout management component.

The internal SIM card (3) sends its profile or information stored in it viz, the GSM or CDMA or other appropriate transmission protocols stack, the address book, messages and applications, to the cellular based device (2). The application area of the SIM card (3) has the device independent multi-lingual application in the form of a language manager. Along with the other profile of the SIM card (3), the multi-lingual application is also sent to the cellular based device (2). The profile also contains along with the GSM stack, address book, messaging module and application, information like size, type of loading support required from the cellular based device, etc.

On receipt of the profiles from the SIM card (3), the cellular based device (2), acknowledges the receipt of the profile to the SIM card (3). The cellular based device (2) reads the internal SIM card (3) and loads the multi-lingual messaging application into the main menu of the cellular based device (2). This service menu of the multi-lingual messaging application is visible in the output unit (4) of the cellular based device (2). The multi-lingual messaging application is now visible in the main menu of the cellular based device (2) along with other applications like settings, profiles, address book etc.

The user selects the multi-lingual messaging application by means of an input unit (1). On selection of the multi-lingual messaging application, the application is loaded into the cellular based device's (2) cache memory (2a). After the application if loaded into the cache memory (2a), the service menu of the multi-lingual messaging application is displayed. The service menu, which appears on the display, is depicted as “A” in FIG. 5. To view already received mails the user has to select ‘Inbox’ from the service menu. To view ‘drafts’, ‘outbox’ and ‘sent items’, the user has to select the corresponding options from the service menu. In order to send a message using SMS (Short Messaging Service) the user has to select the ‘Write Message’ option from the service menu of the multi-lingual messaging application. The user has to select the desired language from a drop-down menu showing the list of plurality of languages, which is stored in the database unit and is available in the present multi-lingual application. The appearance of the list of languages is shown as ‘B’ in FIG. 5. After selecting the desired language, a prompting menu “C” of the character set of the language along with the character modifiers is displayed in a user-friendly mode by means of an input member (1).

The user has to select the desired character from the list of characters displayed on the menu-based language deck (as shown in FIG. 6) in the display member (4). On depression of the desired character to be displayed by means of the input member (1), the keyboard interface adapter interfaces the key-depression provided at the input member (1). Each depression of the input member (1) is mapped with corresponding address locations in the database member which is a part of the character formation member of the language manager. The mapping arrangement in the present invention is conventional one that is prevalent in any digital processing systems. Each key of the input member (1) is mapped in the mapping table to correspond with a particular address of the address location in the database member. As soon as a particular key is depressed, a signal is communicated to the language manager, which retrieves the corresponding address from the database member and shifts the same to the memory member (2a).

For instance, if a user desires to display a character having a character-modifier combination, the flow of events is as follows:

For instance, in order to key in a Kannada (A South Indian language) alphabet [symbol] the user follows following set of instructions.

For the sake of this example, it is assumed that the type of selection of the characters available to the user is an individual selection or manual selection. The user initially depresses a key, depressing which the character set which he desires will appear. The keys are allotted according to the alphabet of the language or Varnamala. In the instant case, the character set for this key is retrieved by depressing the key “1”. When the key “1” is depressed the following language deck appears on the display for the perusal of the user.

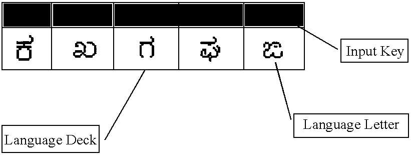

Since the user desires to select a character [symbol] which is the first character of the character set as shown in the above language deck, the corresponding key of the input member (1), (ie. key number 1) to select the desired character.

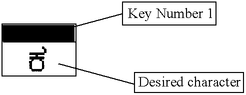

By selecting the key number, a process to display the first character of the selected character set of the language deck on the display member (4) is initiated.

In another example a language such as Chinese is considered:

When individual selection or manual selection is performed for the Chinese language by the user, by depressing a suitable key, the character set which he desires will appear. The keys are allotted according to the alphabet of the language. In the instant case of the Chinese language, the desired character set is retrieved by depressing the key “1”. When the key “1” is depressed the following language deck appears on the display for the perusal of the user.

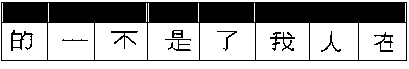

Suppose the user desires to select a character [symbol] , which is the first character of the character set as shown in the above language deck, the corresponding key of the input member (1), (ie. key number 1) is depressed to select the desired character.

When the user referring to the language deck selects a character, by means of the input member (1), mapping process is initiated and the selected character is mapped in the mapping table to correspond with a particular address of the address location in the database member.

No sooner than particular key is depressed (It may be noted here that depression of key includes other forms of inputs such as touch screen input, stylus input etc.,) a signal is communicated to the language manager, which retrieves the corresponding address from the database member shifts the same in the memory member (2a). The appropriate address of the address location for the selected character that is fetched from the database member is shifted to the memory member (2a). Now, the memory member (2a) is provided with the address of the selected character, whose corresponding address location resides in the database member. The address location of the database member comprises corresponding character profile generating executables.

Once the relevant address is shifted to the memory member (2a), the language manager secures the corresponding character generating executables from the address location pointed out by the address stored in the memory member (2a). The secured character generating executables are also stored in the memory member (2a) by the language manager.

Once the character generating executable for the selected character is stored in the memory member (2a), the language manager finally executes the character generating executables to generate a pixel sequence which is associated with the shape of the selected character. The generated pixel sequence is then stored in the memory member (2a). The layout management tasks which form a part of the character formation member is also retrieved by the language manager, which is used to fine-tune the generated pixel sequence.

The functional steps of the character generating executables are as follows:
I. Reading Screen Resolution from environment settings
II. Picking up appropriate character matrix ratio, where matrix ratio depends on output unit. For instance, if the dots per inch (dpi) are 72 then pick 24×24 matrix ratio for the character.
III. Starting Global counter or character positioning counter ‘g’ with an initial value equal to 1, where “1” is the left coordinates of the output unit
IV. Starting Outer loop counter or pixel column counter from 0 to 23 (columns)
V. Starting inner loop counter or pixel row counter from 0 to 23 (rows)
VI. Reading row value and plot appropriate dots (pixels)
VII. Incrementing row counter value by 1
VIII. Ending the loop end—row
IX. Incrementing pixel column counter by 1
X. Ending the loop end—columns
XI. Incrementing global counter with the value of the width of the letter i.e., 24+space of 2

The character-generating executable takes the address location of the character as a pointer and the corresponding values for generating the character are computed. The main parameters for computation are the environment settings, which include screen resolution in terms or the dots per inch and the extents of the screen expressed as “x” and “y” pixel values. Like 640×480, 1024×768. The pixel sequence that is generated is stored in the form of a matrix. The character matrix ratio is appropriately chosen from 12×12, 16×16, 24×24, etc. For environments like the PDA or Mobile, the display system will be unique or proprietary to OEMs (Original Equipment Manufacturers). The ratio of the matrix will be chosen as 17×24 etc.

Once these parameters are in place, the character-generating executable begins with a global counter, which stores the cursor position relative to the width of the character. Initially this counter is set to the leftmost position of the display member. The display left position is the x-axis position of the first available pixel on a display. Next the counters for incrementing the rows and columns are started. The initial values will be ‘0’ for both and the ending limit will be the ratio value (like 23 for a 24×24 ratio). The row value is read from the string expression, which returns the pixels to be darkened (whose value is to be set for ‘1’). Each element of the row is incremented until the last pixel of the row limit is reached.

The row counter governs this. When the first row is complete, the column counter is incremented by ‘1’; the routine is repeated for all the rows until the column limit is attained. After the character is fully formed, the global counter is updated with the width of the formed letter and additional count of 2 is added to provide the placeholder for the cursor.

The output will be returned as a string with pixel information for a 12×12, 16×16 or a 24×24 ratio matrix.

After the address of a character to be formed is computed, then the executable to be applied is for the character formation. The executable compute the following:

Character Base Height:

Depending on the platform like a PC (Personal Computer), PDA (Personal Digital Assistant) or Cellular Phone, the minimum size of Indian language letter will be about 14 to 18 points depending on the language.

For a resolution of 79×81 dots per inch, the width is about 10 pixels and the character height is about 14 pixels

The higher the dots per inch the number of corresponding pixels will be more. For instance, in a PC environment, the difference in Picture quality on a 640×480 pixels and 800×600 pixels is because of the size of the pixel. Higher the resolutions smaller will be the pixel size

This setting is automatically calculated by the layout manager depending on the environment and display settings.

Character Matrix Ratio:

Based on the display settings and permissible client width of an environment the character matrix ratio has to be adjusted. Client width signifies the space available for the program to draw on the screen.

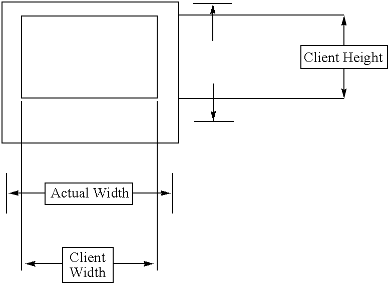

The above figure shows the display of a typical cellular phone. The Client area will be smaller than the actual area of the display. This is the first factor of measurement. The second factor of measurement is the availability of “number of lines” and “number of characters per line”. On a typical cellular phone, 3-5 lines are supported with about 20 characters per line. This will be smaller for older phones and for the advanced phones the number of lines will extend. However in this case the Standard SMS (Short Messaging Service) protocol limits the message width to 160 characters.

Based on these parameters, the character matrix is calculated. The possible combinations are:
12×12
16×16
24×24
17×24

All the values are in pixels

Actual Character Data

The actual data about a character is stored in the form of a character-generating executable. The matrix is generated when the character is selected by the user and the address location for that character is secured and the data in the address location, which basically is a character generating executable to that character, is finally executed. A typical pixelized matrix representation of a character will be in the ratio as described above. A depiction of the matrix for the character [symbol] is shown in FIG. 8.

In FIG. 8, the digital areas of matrix of a character to be displayed are categorized into display and non-display areas. The displayed pixels are marked as dots, which carry the pixel information as “1” and non-displayed pixels are blank are null or “0” respectively.

This matrix is read by appropriate functions and the output is sent to the Operating System specific output unit (4). The result is the display of the character on the PC Screen or a PDA or on a Cellular Phone as an Image.

Once the character image is generated as specified above, display of the character is performed in conjunction with Unicode Standards (UTF-8).

In order to illustrate the formation of the pixel sequence, we consider an exemplary embodiment. For instance, if the pixel sequence has to be generated for a character

[symbol]

The pixel sequence generation formation detail for the above character is represented below in the form of Binary data or HEX data.

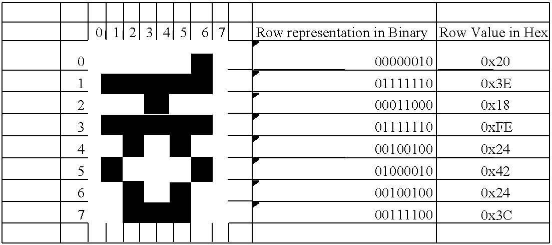

The above figure represents the pixel sequence generation details of the above character. The ratio of formation is 8×8 pixels.

In order to generate the above pixel sequence, the following steps are adopted:
a. Reading screen resolution from environment settings
b. Picking up appropriate character matrix ratio, where matrix ratio depends on output unit. For instance, consider 8×8 matrix ratio for the character.
c. Starting Global counter ‘g’ with an initial value equal to 1, where “1” is the left coordinates of the output unit
d. Starting Outer loop counter from 0 to 7 (columns)
e. Starting inner loop counter from 0 to 7 (rows)
f. Reading row value and plot appropriate dots (pixels)
g. Incrementing row by 1
h. Ending loop—row
i. Incrementing column by 1
j. Ending loop end—columns
k. Incrementing global counter with the value of the width of the letter i.e., 8+space of 2 (determined by Layout Manager)

Some of the important stages of the formation of the above pixelized image are provided below:

Stage 1

Filling of the pixels begins in Row—1 and continues till the end of the Row. The formed picture would look as below: 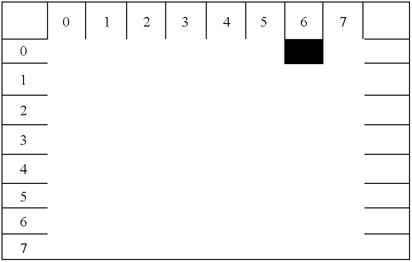
Stage—2

Filling of the pixels begins in Row—2 and continues till the end of the Row. The formed picture would look as below: 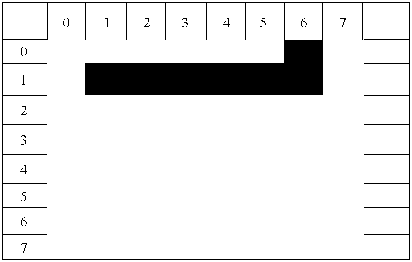
Stage—3

Filling of the pixels begins in Row—5 and continues till the end of the Row. The formed picture would look as below: 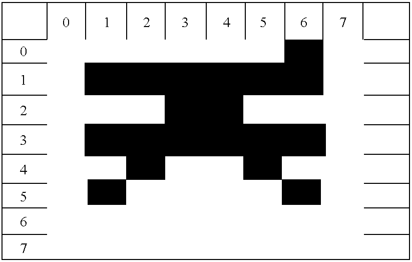
Stage—4

Filling of the pixels begins in Row—6 and continues till the end of the Row. The formed picture would look as below: 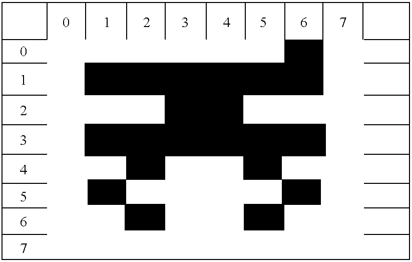
Stage—5

Filling of the pixels begins in Row—7 and continues till the end of the Row. The formed picture would look as below:

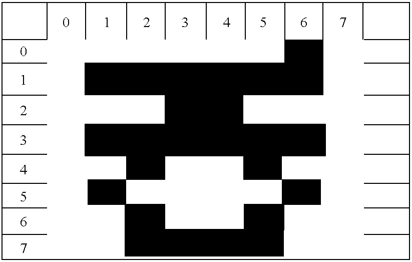

This is the completed pixel sequence of the character

[symbol]

The generated pixel sequence is associated with the shape of the character and/or character modifier from the database member.

The formation of character modifiers and their linking to the selected character is explained by referring to FIG. 9.

In the present invention, the desired modifiers are welded to the characters before merger and display. For instance, if a single character is keyed the same is displayed on the display member (4). However, if the user desires to add character-modifiers to the above displayed character, a suitable key of a modifier is depressed to generate the desired character-modifier at the display member (4) and said modifier is positioned at a pre-determined place near placed the selected character. The placement of the character-modifier is decided in accordance with the layout management tasks stored in the display driver. Once the character and the character-modifiers are placed close to each other, the modifiers are combined or merged to form a single unit.

After the generation of the pixel sequence by the language manager, the generated pixel sequence is stored in the memory member (2a). The language manager then invokes the layout management tasks corresponding to the resultant character from the display driver. The layout management tasks are divided into three main tasks, which are scaling height and width of character to be displayed, fusing or merging the scaled character with the scaled modifier and also determining the space between any two resultant characters.

The language manager then finally executes the layout management tasks that were invoked from the display driver. During the process of execution of the layout management tasks, initially the scaling of the height and the width of the generated pixel sequence of the character is performed. For determining the scale height and width of the pixel sequence of the character, the recorded data, which was initially stored in the memory during the power-on of the system, is used. Accordingly, the scaling of the height and the width of the desired character is performed as per the dimensions of the display member (4) of the system as well as considering the dots per inch or resolution of the display member (4).

In case the user desires to have a character modifier also in addition to the character already selected, then the above steps of selection of the desired character modifier, fetching of appropriate address location, shifting the address of address location to memory, securing and executing the corresponding character modifier profile generating executables, invoking and executing the layout management tasks are repeated again for the character modifier.

When the user also selects a character modifier, the scaling step of the layout management tasks also involves adjustment of the height and width of the character modifier. The character and the character modifier are scaled or trimmed to the extent required. The different steps involved in scaling and merging of the character and character modifier are depicted in FIG. 9. Once the character and the character modifier are scaled to the desired requirement, then scaled character and scaled character modifier are merged together at the merge point, as depicted in FIG. 9.

In another embodiment of present invention, the dynamic rendering of characters does not depend upon the fonts or Unicode. This dynamic rendering of characters is achieved by use of character profile generating executables to create the language characters dynamically. Dynamic rendering uses the mechanism of pixels, strokes, glyphs to produce the shape of the characters on the display member (4).

The process of merging of character-modifiers with the character is depicted in the form of following examples.

### EXAMPLE 1

The steps involved in the merging process of the character [symbol] is graphically represented as follows:

[image]

### EXAMPLE 2

In this example, a combination of character modifier with the corresponding character and their respective address locations are shown. On depression of consonant, the consonant is displayed and thereafter the desired character modifier is selected. The character and character modifier are merged to form a resultant character along with fused modifiers.

The phonetic representations of the above Indian characters are provided in English for easier understanding.
k+A=kA

Next, the second key depression produces the vowel sign. The results of this example are depicted in FIG. 9. As seen from FIG. 9, the vowel sign is placed next to the consonant, the necessary scaling of the second character will be handled by the layout management tasks. Layout management tasks stored in the database member provide the scaling of data for formation of resultant character with fused character modifiers. Scaling of character and character-modifier is performed by scaling few columns of character matrix and few columns of a character-modifier matrix, this scaling done according data available in the layout management tasks and according to the type of character and modifier combination. After the scaling, the merging of the scaled character and character-modifier to form a resultant character with fused character modifiers takes place. FIG. 9(c) shows the final resultant character with fused modifier.

In an embodiment of the present invention, the process of merging of individual glyphs to form a single entity reduces the total number of glyphs to nearly 50%.

The space adjustment as performed in the present invention is exemplified in the following example. In this example, a word from Kannada language is chosen to show the space adjustment and hyphenation.

### EXAMPLE 3

The user selects the steps for the formation of a series of characters sequentially. The processor invokes the layout management task, which determine the spacing between any two resultant characters along with their fused modifiers. The layout management tasks also determine the spacing within each individual character, wherever applicable (especially for Indian languages).

Finally, after the resultant character is formed along with the merged modifier, the same is displayed on the display member of the system of the present invention.

[image]

An example of character formation and display in Chinese language by using the method and system of the present invention is exemplified in the following example.

### EXAMPLE 4

This example is to illustrate the merging process used in Chinese Language. The original character is depicted as (i) and the character after the process of merging is depicted as (ii):

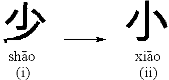

The above steps are repeated each time a key is pressed on the input unit (1). The series of resultant characters along with fused modifiers is displayed to form a message which needs to be transmitted. The SMS has a limit of 160 characters in case GSM protocol is selected and a limit of 140 characters in case CDMA protocol is selected, and these many characters can be entered. When the message is finished, the user presses the send option to send the message to the desired destination. The resultant message is encoded as a 7-bit GSM or UCS-2 and is transmitted to another cellular device. For transmission of the message the GSM protocol is used. ASCII 7-bit protocol is used where the control characters are unavailable. The total characters available are 128 in ASCII. The message is finally sent as standard SMS. The sequence of message transmission is shown below:

[image]

The message which is typed in the form of a series of characters and/or character modifiers placed serially, is transmitted using the data input output interface of the SIM card, before which the message is encoded as a ASCII 7 bit data and then encrypted and send through GSM or CDMA protocol or other appropriate protocols to a GSM or CDMA or other appropriate protocol server. The encrypted message sent to the GSM or CDMA or other appropriate protocol server is retransmitted to the destination cellular device by means of a transmission tower.

After the message is sent, the multi-lingual application is closed and the user returns back to the main menu of the mobile equipment. The message is received by the receiver to whom the message was sent using cellular based device (2) provided with the multi-lingual messaging application of the present invention. To read the message the user has to select the application main menu and select the ‘inbox’ option in the main menu. The message will be displayed at the display member or output unit (4) of the cellular based device (2).

Another embodiment of the present invention is the provision of the features of product migration which includes intelligent translation, transliteration and transformation. This feature enables the users to exchange SMS messages in different languages with automatic translation and transliteration. For example a user can send the message in an Indian language like Tamil and the receiver can receive the same message in some other language like Chinese. A migration module is provided in the transmission protocol server to perform product migration which includes performance of intelligent translation and transliteration of the message. The transmission protocol server in case of the GSM transmission is the GSM protocol server and in case of CDMA transmission is the CDMA protocol server. The protocol servers have a Short Message Service Center (SMSC) which will route the SMS's from one cellular based device to another cellular based device. The actual message migration (i.e, translation, transliteration or transformation) occurs in the protocol server while retaining complete meaning and context to the message.

The server processes the received message and migrates (translates or transliterates) the message into the target language and verifies the accuracy and context of the migrated message. Further the migrated message is converted to a standard pure picture message which can received by any cellular device. The target cellular based device or its SIM Card is optionally equipped with or without an inbuilt language manager for implementing pixel-based multi-lingual Unicode compatible messaging applications. In other words the receiving cellular device need not have the multi-lingual messaging application of the present invention installed in it, but still the message can be received by the cellular device in any language the sender desires. The above feature of migration of the sent message is understood best with the help of the following example. However, the example should not be construed to limit the scope of the invention and the same is provided only for better understanding.

### EXAMPLE 5

Here the user types in the message “How are you?” in a south Indian language Kannada.

[image]

The user sends this message to the transmission protocol server along with the recipient's cellular number and a flag indicating the target language which the user intends the receiver to receive in. Considering that the user would like the receiver to receive the message in Chinese, he will select the target language to be Chinese and will send the SMS to the protocol server. The actual message translation occurs in the protocol server while retaining complete meaning and context to the message.

The server processes the received message and translates the message into the target language and verifies the accuracy and context of the translated message. Further the translated message is converted to a standard pure picture message which can received by any cellular device. The translated message will be sent to the receiver cellular device by the server. The receiver will receive the same message in Chinese, as shown below.

[image]

The receiver cellular device need not have the multi-lingual messaging application of the present invention installed in it, but still the message can be received by the cellular device in any language the sender desires.

Advantages

1. The multi-lingual messaging application of the present invention is device independent and is universal for all types of cellular devices.
2. The multi-lingual messaging application of the present invention can be accommodated within a standard GSM or CDMA or other appropriate transmission protocol SIM card.
3. The multi-lingual messaging application of the present invention is of low size and can be accommodated within the application area of the SIM card.
4. The multi-lingual messaging application of the present invention provides a user-friendly entry of characters in the mobile equipment.
5. The multi-lingual messaging application of the present invention provides SMS service in multiple languages.
6. The multi-lingual messaging application of the present invention provides product migration (i.e, translation and transliteration) of the SMS into any language before transmission to the receiver.
7. The multi-lingual messaging application of the present invention uses the standard GSM or CDMA or other appropriate transmission protocol for transmission of messages.
8. The present invention provides a menu based and advanced key logic which will enable a user to type easily and faster.

We claim:

1. A Subscriber Identification Module (SIM) Card with an inbuilt language manager for implementing pixel-based multi-lingual Unicode compatible messaging applications, said SIM Card comprising:
(a) a character formation member, said member is a pixel-based renderer of multi-lingual characters from a combination of glyphs,
(b) an intelligent text input module to input characters in the user-selected language, said module driven by keypad driver, and
(c) a display driver to effect the display of fused or merged characters in a series to form a message, and
(d) a transmission protocol to transmit the message.

2. The SIM Card as claimed in claim 1, wherein the character formation member further comprising;
(a) a database member to store languages, address locations having character and/or character modifier profile generating executables,
(b) a layout management component disposed to scale the height and width of the character and character modifier as per dimensions and dots per inch of display,
(c) said layout management component also disposed to fuse or merge the scaled character with the scaled character modifier at the points of scaling, to form the resultant character along with the fused modifier, and
(d) said layout management component further disposed to determine spacing between any two resultant characters and spacing within each individual character, wherever applicable.

3. The SIM Card as claimed in claim 1, wherein the intelligent text input module having a language menu to select the desired language, character group and character.

4. A system for implementing pixel-based multi-lingual Unicode compatible messaging applications, said system comprising:
(a) input and output units,
(b) an internal SIM card disposed with an inbuilt language manager for implementing pixel-based multi-lingual Unicode compatible messaging applications,
(c) a cellular based device and
(d) a migration module to perform product migration of the transmitted message, said migration module disposed in a transmission protocol server.

5. The system as claimed in claim 4, wherein the internal SIM card further comprising;
(a) a character formation member, said member is a pixel-based renderer of multi-lingual characters from a combination of glyphs,
(b) an intelligent text input module to input characters in the user-selected language, said module driven by keypad driver, and
(c) a display driver to effect the display of fused or merged characters in a series to form a message, and
(d) a transmission protocol to transmit the message.

6. A method for implementing pixel-based multi-lingual Unicode compatible messaging applications in cellular-based communications, said method comprising the steps of:
(a) establishing the functional linkage between the Subscriber Identification Module (SIM) Card with an inbuilt language manager for implementing pixel-based multi-lingual Unicode compatible messaging applications and cellular based device,
(b) selecting the desired messaging application,
(c) selecting a language from a plurality of languages and prompting a menu of its character set along with modifiers in a user-friendly mode, by means of an input member, said languages stored in a database member,
(d) choosing a character and/or character modifier to be displayed from said selected language from said database member,
(e) fetching an appropriate address of the address location for said character and/or character modifier by mapping from said database member, said address location comprising corresponding character and/or character modifier profile generating executables,
(f) shifting the address of the selected address location to a memory member,
(g) securing the corresponding character and/or character modifier profile generating executables from said address location, into the memory member, by a processor,
(h) generating a pixel sequence, which is associated with the shape of the character and/or character modifier and storing the same in the memory,
(i) invoking the layout management tasks corresponding to the resultant character and/or character modifier from the database,
(j) executing layout management tasks and displaying the resultant character along with the fused modifier, wherever applicable,
(k) displaying series of resultant characters along with fused modifiers by repeating the aforesaid steps to form a message,
(l) transmitting the resultant message to transmission protocol server,
(m) performing product migration of transmitted message within transmission protocol server and
(n) retransmitting product migrated message from said transmission protocol server to another cellular based device.

7. The method according to claim 6, wherein the selected language is a Unicode compatible language.

8. The method according to claim 6, wherein the language and character set menu is selected either individually or by way of scrolling.

9. The method according to claim 6, wherein the generating of pixel sequence having a desired character width and height, said method comprising the steps of:
(a) reading display resolution from environment settings,
(b) picking up appropriate character matrix ratio for the selected display unit,
(c) initializing a character positioning counter with an initial value of “1”, where “1” is the left-most coordinate of the selected display unit,
(d) initializing the pixel column counter with “0”,
(e) initializing the pixel row counter with “0”,
(f) reading the row and column values iteratively and plotting appropriate pixel to form a pixelized character matrix till the terminal row and column counters equal to “n”, and incrementing the value of pixel column and row counters by 1, and
(g) incrementing the character positioning counter after the formation of a single character and/or modifier by a pre-determined value and generating the final form of character derived from pixel matrix.

10. The method according to claim 6, wherein the target cellular based device or its SIM Card is optionally equipped with or without an inbuilt language manager for implementing pixel-based multi-lingual Unicode compatible messaging applications.
